(19) United States
(12) Patent Application Publication
(10) Pub. No.: US 2005/0278426 A1
(43) Pub. Date: Dec. 15, 2005

(54) Systems and methods for merging communications

(75) Inventor: Lynn Holm Blagg, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/869,049

(22) Filed: Jun. 15, 2004

(51) Int. Cl. G06F 15/16

(52) U.S. Cl. 709/204; 709/236

(57) ABSTRACT

Embodiments of the invention provide systems and methods for merging and/or consolidating a plurality of communications. In some cases, the plurality of communications may be included in a single communication medium, which can be, merely by way of example, a postal mailing (e.g., a letter, etc.), an electronic message, a facsimile message, a short messaging service (SMS) message, a pager message, a web page, a telephone call to a recipient of the communications, a telephone call from a recipient of the communications, and/or the like. In some cases, one or more of the plurality of communications may relate to an account held by the recipient of the message with the sender of the message, while in other cases, certain of the plurality of communications may relate to one or more additional accounts with the sender. These additional accounts may be held by the recipient and/or by associates of the recipient, such as family members, employees, and/or the like.

### BACKGROUND OF THE INVENTION

One issue facing many organizations is how to interface with frequent correspondents most efficiently. For example, many companies send periodic mailings to customers. Such mailings can include advertisements and other promotional materials, account information, legal notices, and a variety of other communications. In the past, companies generally were forced to send single-issue messages for each type of communication, perhaps with broadcast (i.e., non-customized) advertising materials inserted into the same envelope.

As communication technology matured, companies began to develop the ability to include relatively “customized” advertising materials with other messages, as well as the ability to group different accounts, which could possibly provide a facility for providing a single communication for multiple accounts. Merely by way of example, U.S. application Ser. No. 09/298,417, filed Apr. 23, 1999 by Blagg et al. and entitled “Method for Processing a Group of Accounts Corresponding to Different Products,” the entire disclosure of which is incorporated herein for all purposes, describes various methods and systems for grouping accounts.

In addition, companies have begun to seek other ways in which to control the types and nature of communications sent to frequent correspondents. For example, U.S. application Ser. No. 10/672,596, filed Sep. 26, 2003 by Blagg et al. and entitled “Systems and Methods for Participant Controlled Communications Regarding Financial Accounts,” the entire disclosure of which is incorporated herein for all purposes, illustrates some ways of controlling such communications. U.S. application Ser. No. 10/353,778, filed Jan. 27, 2003 by Albee et al. and entitled “Methods and Systems for Consolidating Financial Reporting Information,” the entire disclosure of which is also incorporated herein by reference, describes various ways in which information may be disclosed to a recipient.

Other strategies of providing information to a recipient have been employed as well. Merely by way of example, some companies have attempted to utilize free space on a bill, account statement, etc. to present additional advertising materials to the recipient. Often, however, such practices have been limited to adding generalized advertisements and/or materials that otherwise would not be sent to the recipient-they generally do not involve consolidating in a single mailing independent communications for the same recipient.

Despite these advances, organizations continue to seek new ways in which to enhance the efficiency and cost-effectiveness of communications with frequent correspondents. For example, those skilled in the art will appreciate that companies often employ separate “triggers” for different types of communications, such as account information, customized promotional materials and legal notices, just to name a few, and that those triggers generally will be independent of one another. Consequently, each trigger may cause the transmission of a separate correspondence, such that a company may send multiple communications to a single recipient over a relatively short span of time, promoting inefficiency and increasing communication costs. There exists a need, therefore, for a solution that allows the consolidation of communications to provide even greater efficiency, particularly for companies that employ frequent communications with correspondents.

### BRIEF SUMMARY OF THE INVENTION

Embodiments of the invention provide systems and methods for merging and/or consolidating a plurality of communications. In some cases, the plurality of communications may be included in a single communication medium, which can be, merely by way of example, a postal mailing (e.g., a letter, etc.), an electronic message, a facsimile message, a short messaging service (SMS) message, a pager message, a web page, a telephone call to a recipient of the communications, a telephone call from a recipient of the communications, and/or the like. In some cases, one or more of the plurality of communications may relate to an account held by the recipient of the message with the sender of the message, while in other cases, certain of the plurality of communications may relate to one or more additional accounts with the sender. These additional accounts may be held by the recipient and/or by associates of the recipient, such as family members, employees, and/or the like.

Embodiments of the invention can support the merging of any appropriate communications, including, again merely by way of example, promotional messages, legal notifications, statements regarding the status of relevant accounts, delinquency statements, and the like. Various embodiments of the invention, therefore, can provide an automated, efficient and/or cost-effective way for the sender to consolidate a plurality of communications to a recipient, which can lead to cost savings for the sender and/or enhanced convenience for the sender and/or recipient.

Merely by way of example, one set of embodiments provides methods for merging communications. For example, an exemplary embodiment provides, in a relationship between a sender and a recipient, a method of using a computer system to consolidate a plurality of communications to the recipient. The method can include providing a communication medium and receiving a first trigger. The first trigger may be configured to instruct the computer system that a first communication is available for transmission to the recipient. The method can further include, in response to the first trigger, accessing a first communication for transmission to the recipient and/or inserting a first communication component into the communication medium; the first communication component can comprise the first communication.

In some embodiments, the method can further comprise receiving a second trigger, which might be independent of the first trigger; the second trigger may be configured to instruct the computer system that an additional communication may be available for transmission to the recipient, and the additional communication can be independent of the first communication. The method might also include determining the suitability of the additional communication for inclusion in the communication medium and/or inserting a second communication component into the communication medium; in such cases, the second communication component might comprise the additional communication. In other cases, the second communication component may be incorporated within the first communication component. The method can further include arranging at least one of the communication components within the communication medium, perhaps based on business rules, and/or formatting at least one of the communication components.

Often (but not always), the method may include determining whether the additional communication should be transmitted with the first communication. This determination can comprise specifying that the additional communication should be transmitted according to a certain schedule (e.g., before a certain date) and/or if the additional communication is considered urgent. A communication may, in some instances, be considered urgent if it has been pending for a certain number of days. If it is determined that the additional communication should not be transmitted with the first communication, the additional communication may be held in a hold file for possible inclusion in a future communication medium, and/or the additional communication may be reviewed at a subsequent time to determine whether the additional communication should be transmitted at that subsequent time.

In certain embodiments, the method will include generating the first and/or additional communications, and/or the trigger(s) can comprise the generation of the communications. In other embodiments, the first communication can be a scheduled communication, and the first trigger can be a schedule that specifies when the first communication should be transmitted. Alternatively and/or in addition, the first communication can be associated with a first account (which may or may not be associated with the recipient), and/or the first trigger can be related to an activity associated with the first account. Likewise, the additional communication may be associated with a second account. The first account may be related to the second account and/or the first and second accounts may be associated with a single entity, which can be a business, an individual, etc. In other cases, the first account may be associated with a first entity and the second account may be associated with a second entity. Either the first or second entities may be a business and/or an individual, and the second entity may be a dependent, employee, etc. of the first entity (or vice-versa). In some cases, financial responsibility for both accounts may be vested with a single entity.

In accordance with various embodiments of the invention, a variety of communications may be supported. Merely by way of example, a communication can comprise a legal notification about an account, a welcome notification for an account, a marketing message, and/or the like. Likewise, a communication medium can take a variety of forms, including without limitation an account statement (and/or an insert thereto), an electronic mail message, a postal mailing, a letter, a short messaging service message, a pager message, a telephone call to a recipient (and/or a response to a telephone call from a recipient), and/or the like.

A further set of embodiments provides, in a relationship between a sender and a recipient, a method of consolidating a plurality of communications to the recipient using a computer system. The method can comprise providing a first communication that is available for transmission to the recipient, determining whether the first communication should be transmitted to the recipient, and, if the first communication should be transmitted to the recipient, inserting a first communication component (which may comprise the first communication) into a communication medium, and/or determining whether an additional communication is pending to be sent to the recipient. If there is an additional communication pending, the method can include inserting a second communication component into the communication medium, the second communication component comprising the additional communication. The method can also include transmitting the communication medium.

Optionally, the method can include determining the suitability of the additional communication for inclusion in the communication medium. This determination can take any of several forms, including without limitation analyzing whether a content of the additional communication is compatible with a content of the first communication. In addition, the method optionally can include determining, perhaps based on a business rule, that the first communication should be transmitted using a particular type of communication medium and/or determining the suitability of the additional communication for inclusion in the particular type of communication medium. In such cases, inserting a first communication component into a communication medium may comprise inserting the first communication into a communication medium of the particular type.

If the first communication should not be transmitted to the recipient, the method can comprise adding the first communication to a hold file for inclusion in a subsequent communication medium. Determining whether the first communication should be transmitted to the recipient can comprise determining whether the first communication meets urgency criteria, which can include determining an interval during which the first communication should be transmitted to the recipient and determining whether a pending communication has been scheduled for transmission to the recipient during the interval. If a pending communication has been scheduled for transmission to the recipient during the interval, the method can further include determining whether the first communication is suitable for inclusion with the pending communication.

Other embodiments provide systems for consolidating a plurality of communications, including systems and/or computer systems configured (and/or comprising instructions executable by a processor) to implement the methods described above and elsewhere herein. Merely by way of example, one set of embodiments can provide, in a relationship between an account holder and an account issuer, a computer system for consolidating a plurality of communications to the account holder.

The system can comprise a processor and a computer readable storage medium in communication with the processor, such that the storage medium can comprise instructions executable by the processor to provide a communication medium and receive a first trigger configured to instruct the computer system that a first communication is available for transmission to the account holder. In response to the first trigger, the instructions may provide for accessing a first communication component for transmission to the account holder, and the first communication component can comprise the first communication. The instructions may further be executable by the processor to receive a second trigger, which can be configured to instruct the computer system that an additional communication may be available for transmission to the account holder. In some embodiments, the second trigger is independent of the first trigger. Finally, the instructions can be executable to determine the suitability of the additional communication for inclusion in the communication medium.

Another set of embodiments provides, in a relationship between a sender and a recipient, a computer system for consolidating a plurality of communications to the recipient. The computer system can comprise a processor and a computer readable storage medium in communication with the processor. The computer readable storage medium may comprise instructions executable by the processor to provide a first communication that is available for transmission to the recipient, determine whether the first communication should be transmitted to the recipient, and if the first communication should be transmitted to the recipient, insert a first communication component (which can comprise the first communication) into a communication medium. The instructions can further be executable to determine whether an additional communication is pending to be sent to the recipient, and the additional communication can independent of the first communication. If there is an additional communication pending, a second communication component (which can comprise the additional communication) may be inserted into the communication medium. Optionally, the communication medium can be transmitted. If the first communication should not be transmitted to the recipient, the instructions can be executable to add the first communication to a hold file for inclusion in a subsequent communication medium.

In yet another set of embodiments, a computer system may be provided for consolidating a plurality of communications to the recipient. In some embodiments, the system comprises a communication store configured to store a plurality of communications for the recipient, a rules engine in communication with the communication store and/or a composition manager in communication with the rules engine. The rules engine may be configured to determine whether any of the plurality of communications should be transmitted to the recipient at a particular time, and if any of the plurality of communications should be transmitted to the recipient, to select that communication for transmission. The composition manager may be configured to access the selected communication and insert a first communication component into a communication medium, the first communication component comprising the selected communication.

The rules engine and/or the composition manager may be embodied by a computer processor and/or by instructions executed by a computer processor. The communications store may comprise a hold file and/or any other data storage structure, such as a database, etc. The system may further comprise a rule store in communication with the rules engine, and the rule store can comprise a set of business rules specifying criteria for determining when a communication should be transmitted to a recipient. Such criteria can specify that a communication should be transmitted according to a certain schedule (e.g., before a certain date, etc.) and/or if the communication is considered urgent. Merely by way of example, a communication may be considered urgent if the communication has remained pending for a certain number of days.

Optionally, if the rules engine determines that a plurality of communications should be transmitted to the recipient at the particular time, the rules engine can be configured to determine whether each of the plurality of communications is suitable for inclusion with the others of the plurality of communications. (In some cases, each of the plurality of communications will be independent of the others.) Moreover, if the rules engine determines that a plurality of communications should be transmitted to the recipient at the particular time and that at least two of the plurality of communications are suitable for inclusion with each other, the rules engine can be further configured to select all of the at least two communications for transmission.

In such cases, the composition manager might be configured to access each of the at least two communications selected for transmission, insert a plurality of communication components into a communication medium, and arrange each of the plurality of communication components within the communication medium. Each of the communication components often will comprise one of the at least two selected communications. The rules engine can be further configured to provide instructions to the composition manager specifying how to arrange each of the plurality of communication components within the communication medium.

The invention has been summarized briefly above. Those skilled in the art may ascertain additional benefits and features attendant to various embodiments of the invention by reference to the Figures, which are described in detail below.

### BRIEF DESCRIPTION OF THE DRAWINGS

The figures illustrate one or more exemplary embodiments of the invention, which are described in detail in the remaining portions of the specification. In the figures, like reference numerals are used throughout to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates a system that can be used to merge a plurality of communications, in accordance with various embodiments of the invention.

FIG. 2 illustrates a computer system that can be used to merge a plurality of communications, in accordance with various embodiments of the invention.

FIG. 3 illustrates a conceptual drawing of a system for merging a plurality of communications, in accordance with various embodiments of the invention.

FIG. 4 is a process flow diagram illustrating a method of merging communications, in accordance with various embodiments of the invention.

FIG. 5 illustrates an exemplary communication medium that may be produced in accordance with various embodiments of the invention.

### DETAILED DESCRIPTION OF THE INVENTION

1. Overview

Certain embodiments of the invention, which are described in detail below, provide methods and systems for merging and/or consolidating communications between a sender and a recipient. In certain exemplary embodiments described herein, the sender can be an entity, such as a financial institution, merchant, and/or the like, that maintains financial accounts, and/or the recipient can be an entity, such as a customer, depositor, cardholder, etc., that maintains financial responsibility for one or more accounts with the sender and/or is a contact for the account(s). In such embodiments, the recipient may be (but need not be) the holder of one or more of the account(s) and/or may be (but need not be) related to the holder of one or more of the account(s). Merely by way of example, commonly-assigned, co-pending U.S. patent application Ser. Nos. 09/298,417 and 09/298,521, both filed Apr. 23, 1999 by the inventor hereof, and entitled, respectively, “Methods for Processing a Group of Accounts Corresponding to Different Products” and “Methods for Defining a Relationship Between an Account and a Group,” both of which are incorporated herein in their entireties by reference for all purposes, describe in detail methods in which accounts held by an entity and/or group of entities may be associated with one another and/or processed collectively. Certain embodiments of the present invention may facilitate such features by providing methods and systems of consolidating a plurality of communications, each of which may be related to one or more accounts, which may be maintained and/or administered as described in these commonly-assigned applications. Notwithstanding the description of these exemplary embodiments, however, the terms “sender” and “recipient,” as used herein, should be interpreted in a broad sense, to mean, respectively, any entity that transmits one or more communications, via any applicable communication medium, and any entity that is intended to receive these communications.

The term “communication” is used broadly herein to refer to any type of message, information, etc. intended to be conveyed from a sender of the communication to a recipient of the communication. Depending upon embodiment-specific circumstances (such as, for instance, the communication medium used, business rules governing the communication, etc.), a communication can include, inter alia, text, images, numeric data, links to other information (e.g., hyperlinks), audible information (e.g., recorded and/or live voice messages), and the like.

In some cases, a communication may be dependant on another communication. Merely by way of example, if a first communication is created based on an account activity (such as credits and/or debits against the account, the raising of a credit limit), another communication may be created in relation to that first communication (e.g., a special interest rate, etc.). Hence, a dependent communication relates in some way to another communication. In contrast, two communications that potentially could be transmitted may be independent of one another. Merely by way of example, a government-mandated disclosure for a particular account could be scheduled for transmission to a particular recipient, and a separate communication relating to a different account (or the same account) might be created. Although intended for the same recipient, the two communications are otherwise unrelated and therefore can be considered independent of one another.

In some cases, a trigger (described in detail below) may cause the processing of a particular communication for transmission. As with communications, a trigger can be dependent on another trigger (e.g., when the communication indicating a raise in an account's credit limit is triggered for processing, any other communications relating to the account status are also triggered for processing) or independent of other triggers. Based on the disclosure herein, one skilled in the art will appreciate that independent triggers often (but not always) will be associated with independent communications, while dependent triggers often (but, again, not always) will be associated with dependent communications. Thus, if two communications have independent triggers, those two communications generally both should be sent to the recipient, either as separate communications or (in accordance with various embodiments of the invention, for example), as a consolidated communication.

A communication may be incorporated within a “communication component,” which should be thought of as an instance of a communication, optionally with additional information and/or features (such as applied formatting, positioning information and/or the like), and which may be included within one or more communication media. In accordance with some embodiments, a communication may include only specific data intended for the recipient, but incorporation of the communication within the communication component can include the addition of generalized text, images, etc. to provide meaning to the communication. Merely by way of example, the communication may comprise the following data: “David Jones, account number 000001, 30 days delinquent,” but the communication component comprising that communication may read: “Dear David Jones, your account, number 000001, has become 30 days delinquent. Please pay the minimum amount due immediately.”

As mentioned above, one or more communications and/or communication components may be incorporated within a communication medium for transmission to the recipient. A “communication medium,” as that term is used herein, denotes any medium that can be used to compose, hold, embody and/or transmit a communication, and in particular a communication component. Exemplary communication media can include, inter alia, a postal mailing (a term which includes items delivered by the U.S. Postal Service, as well as any other applicable carrier, national postal service, etc.), such as a letter, account statement, invoice, etc.; an electronic message, which can include without limitation a message formatted according to any of several known standards, including, for example, the Simple Mail Transfer Protocol (SMTP), the Short Messaging Service (SMS) protocol and others; a pager message; a telephone call and/or message, including a call initiated by the sender to the recipient and/or a call initiated by the recipient to the sender.

In certain embodiments, therefore, a communication may be created and/or stored in a “hold” file (as discussed in detail below), and a communication component may be created, such that the communication component comprises the communication, as well, perhaps, as other information, as described above. The communication component may be inserted into a communication medium, optionally along with other communication components, each of which can comprise additional communications if desired. Additional details and other embodiments are discussed in further detail below.

2. Detailed Description of Exemplary Embodiments

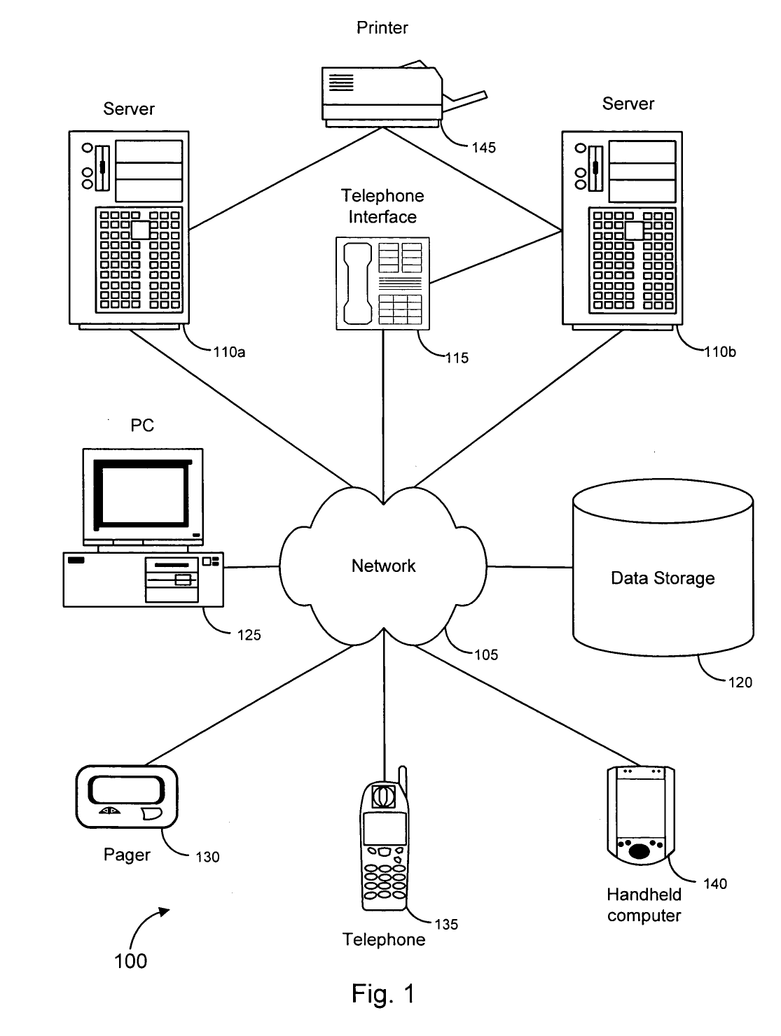

FIG. 1 illustrates a network architecture of a system 100 that can be used in accordance with one set of embodiments. Certain embodiments of the system 100 utilize a networked environment, including a network 105. The network 105 can be any type of network familiar to those skilled in the art that can support data communications using any of a variety of commercially-available protocols, including without limitation TCP/IP, SNA, IPX, AppleTalk, and the like. Merely by way of example, the network 105 can be a local area network (“LAN”) including without limitation an Ethernet network, a Token-Ring network and/or the like; a wide-area network; a virtual network, including without limitation a virtual private network (“VPN”); the Internet; an intranet; an extranet; a telephone network, including without limitation a public switched telephone network (“PSTN”), a wireless telephone network, a private branch exchange (“PBX”) and/or the like; an infra-red network; a wireless network, including without limitation a network operating under any of the IEEE 802.11 suite of protocols, the Bluetooth™ protocol known in the art, and/or any other wireless protocol; and/or any combination of these and/or other networks. The system 100 can also feature a variety of devices described in detail below, which can be in communication with one another, either directly (e.g., via serial connection, parallel connection, etc.) and/or via the network 105.

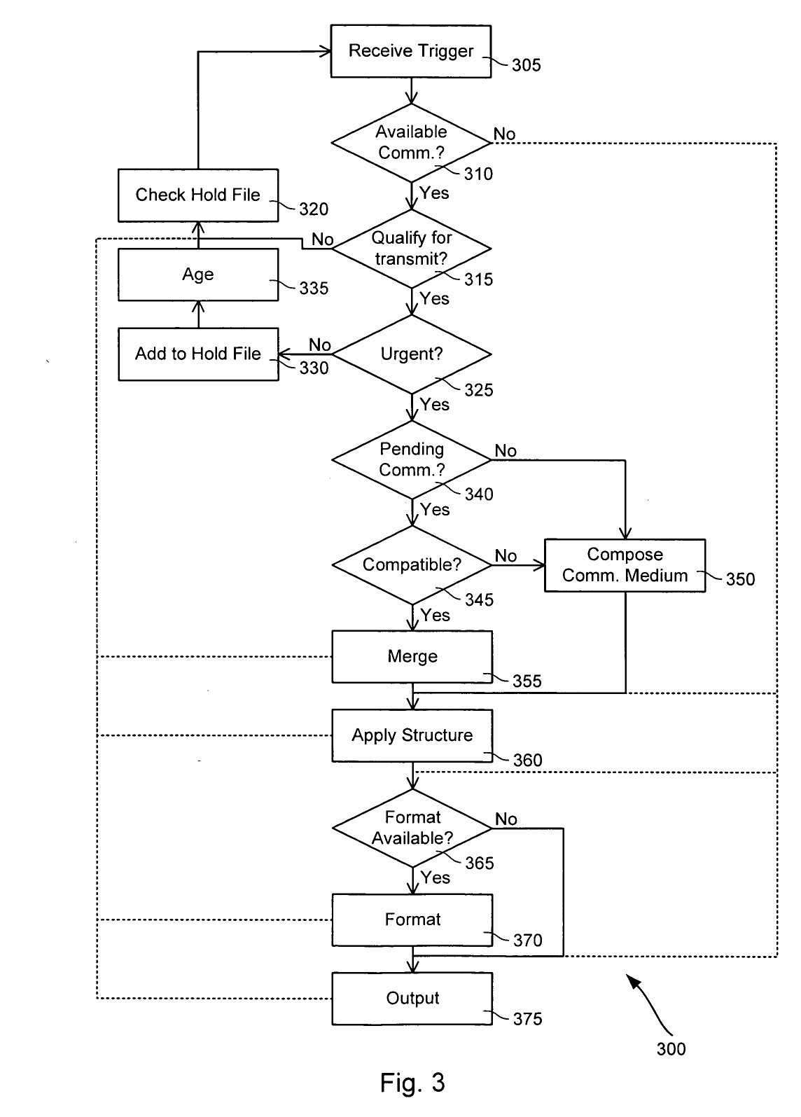

For example, some embodiments can utilize one or more server computers 110, which can serve as communication processing systems in accordance with certain embodiments of the invention. Merely by way of example, a server 110 may incorporate the components described in detail with respect to FIG. 3, discussed infra. The servers 110 each can be running an operating system, including without limitation any of those discussed below, as well as any commercially-available server and/or multi-user operating systems, including, merely by way of example, OS/390™, OS/400™, VMS™, UNIX™ (including any of its varieties and/or similar variants), and the like. The servers 110 can also run a variety of server applications, including HTTP servers, FTP servers, CGI servers, database servers, Java servers, and the like.

The server(s) 110 can also include one or more file servers, application servers and/or transaction processing servers, which can include, in addition to an operating system, one or more applications accessible by a client running on one or more client devices, which can include those devices 125-140 described below. Merely by way of example, the server(s) 110 can be one or more general purpose computers capable of executing programs or scripts in response to requests from and/or interaction with client devices, including without limitation web applications. Such web applications can be implemented as one or more scripts or programs written in any programming language, including merely by way of example, C, C++, Java™, COBOL, or any scripting language, such as Perl, Python, or TCL, or any combination thereof. The servers 110 can also include database server software, including without limitation packages commercially available from Oracle™, Microsoft™, Sybase™, IBM™ and the like, which can process requests from database clients running on a client device. In some embodiments, one or more servers 110 can create web pages dynamically for performing methods of the invention. These web pages can serve as an interface between client devices and the server 110, and can, moreover, serve as a communication medium, as described elsewhere herein. Alternatively, a server 110 may run a server application, while a client device can run a dedicated client application. The server application, therefore, can serve as an interface for the user device running the client application.

In some implementations, a server 110b may include a telephone interface 115, which can allow the server to interact with an ordinary (POTS) telephone and/or any other telephonic device, such as a VoIP device, a wireless phone, etc. The telephone interface 115, which may be implemented in software and/or hardware embodied in the server 110b and/or in a separate device in communication with the server, can provide integrated voice response (“IVR”) features familiar to those skilled in the art. The telephone interface also can be configured to interpret dual tone multi-frequency (“DTMF”) tones as data input. Thus, in accordance with embodiments of the invention, the telephone interface 115 can allow a user to interact with a server 110b via voice and/or DTMF commands; in this way, for example, a telephone call and/or telephone message handled by the server 110b and/or telephone interface can serve as a communication medium in accordance with embodiments. Similarly, a server 110 in accordance with other embodiments can provide communication media in the form of web pages, electronic mail, pager messages and the like through the use of appropriate software and/or interfaces.

In certain embodiments, the system can include a data store 120, which can comprise one or more hard drives, database, etc. The location of the data store 120 is discretionary: Merely by way of example, it can reside on a storage medium local to (and/or resident in) one or more of the server(s) 110 and/or client devices. Alternatively, it can be remote from any or all of these device, so long as it is in communication (e.g., via the network 105) with one or more of these. In some embodiments, the data store 120 can reside in a storage-area network (“SAN”) familiar to those skilled in the art. (Likewise, any necessary files for performing the functions attributed to the servers 110 and/or client devices can be stored locally on the respective computer and/or remotely, as appropriate.) In an embodiment, the data store 120 can comprise a relational database that is adapted to store, update, and retrieve data in response to appropriate commands, including for example, SQL-formatted commands.

As mentioned above, embodiments of the invention can include one or more client devices, which can be in communication with the server(s) 110, e.g., through the network 105 and/or the telephone interface 115. Merely for purposes of illustration, exemplary client devices shown on FIG. 1 include a personal computer 125, a pager 130, a, a telephone 135 (which can be, inter alia, a POTS telephone, wireless telephone, etc.), and a handheld computer 140. Generally, client devices can comprise any device capable of data and/or voice communication. Exemplary client devices can include general purpose personal computers (e.g., 125) (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. Alternatively, a client device can be any other electronic device, such as a “dumb terminal,” thin-client computer, POTS telephone and/or wireless telephone (e.g., 135), Internet-enabled mobile telephone, handheld computer and/or personal digital assistant (e.g., 140), capable of voice and/or data communication, including merely by way of example communication via a computer network and/or displaying and navigating web pages or other types of electronic documents. These client devices 125-140, depending on their capabilities, can also have any of a variety of applications, including one or more database client and/or server applications, and/or web browser applications. Although the exemplary system 100 is shown with four devices, any number of each of the illustrated client devices can be supported, and those skilled in the art will appreciate that the illustrated devices, while exemplary, are not exhaustive of the types of client devices that could be supported by embodiments of the invention.

The exemplary client devices 125-140 illustrated on FIG. 1 may be used by a sender and/or recipient in accordance with embodiments of the invention. Merely by way of example, a recipient may operate a PC 125, pager 130, handheld computer 140, etc. to receive from a server 110 an electronic message, web page, etc. that comprises a communication medium having one or more communication components. Similarly, a telephone 135 may be used by the recipient to conduct a telephone call and/or receive a telephone message, either of which can also comprise a communication medium. Alternatively, one or more of the exemplary client devices 125-140 may be used to access a server 110 to perform various methods described below and/or to configure the behavior of server(s) 110 acting as communication processing systems.

Embodiments utilizing hardcopy (i.e., printed) communication media, such as letters, statements and/or other mailings, may utilize one or more printers 145 to print such mailings, as well as various types of hardware that may be used to prepare such materials for distribution. Merely by way of example, the following commonly-assigned applications, each of which is hereby incorporated by reference in its entirety for all purposes, describe mail handling systems that may be utilized by embodiments of the invention: U.S. patent application Ser. No. 10/045,589, filed Nov. 8, 2001 by Bennett et al. and entitled “System and Methods of Providing Inserts Into Envelopes”; U.S. patent application Ser. No. 10/036,650, filed Nov. 8, 2001 by Smith et al. and entitled “Mail Handling Equipment and Methods” (now U.S. Pat. No. 6,661,217); U.S. patent application Ser. No. 10/029,112, filed Dec. 21, 2001 by Gates et al. and entitled “Sheet Folding Systems and Methods” (now U.S. Pat. No. 6,623,415); U.S. patent application Ser. No. 10/028,449, filed Dec. 19, 2001 by Smith et al. and entitled “Real-Time Intelligent Packet Collation Systems and Methods”; and U.S. patent application Ser. No. 10/232,045, filed Aug. 29, 2002 by Nowlin et al. and entitled “Weight Measuring Systems and Methods for Weighing Items.” The printer 145 may be any suitable printer, including without limitation high-speed commercial printers, laser printers, line printers, and the like.

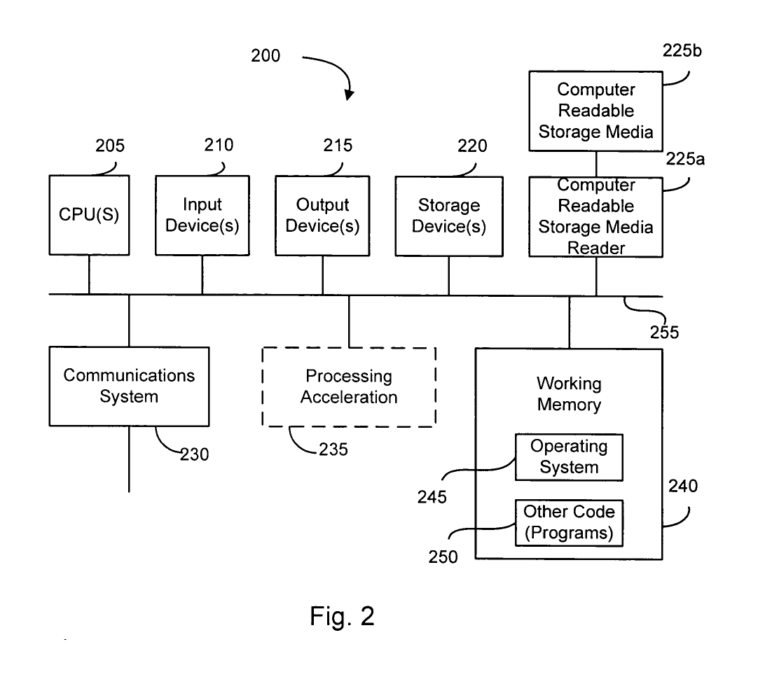

FIG. 2 provides a schematic illustration of one embodiment of a system 200 that can perform the methods of the invention and/or the functions of a client device, server computer and/or communication processing system, as described herein. This figure broadly illustrates how individual system elements may be implemented in a relatively separated or relatively more integrated manner. The system 200 is shown comprising hardware elements that can be coupled electrically via a bus 255, including a processor 205; an input device 210, which can include without limitation a mouse, a keyboard, a numeric keypad, a tablet and/or the like; an output device 215, which can include without limitation a speaker, a display device, a printer and/or the like; a storage device 220, which can include without limitation a disk drive, an optical storage device, solid-state storage device such as a random access memory (“RAM”) and/or a read-only memory (“ROM”), which can be programmable, flash-updateable and/or the like; and a computer-readable storage media reader 225a. The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. Such storage media (sometimes in conjunction with one or more processors, memory devices, instructions and/or the like) can serve as a means to perform many of the storage functions described elsewhere herein.

The computer system 200 can further comprise a communications system 230; which can include without limitation a modem, a network card (wireless or wired), an infra-red communication device, a wireless transceiver and/or antenna, and/or the like. The communications system 230 may permit data to be exchanged with the network 105 and/or any other computer/device described above with respect to the system 100.

The computer system 200 can include a processing acceleration unit 235, which can include a DSP, a special-purpose processor and/or the like; and a memory 240, which can include a RAM or ROM device, as described above.

The computer system 200 also can incorporate software and/or firmware instructions, which can be executed by one or more of the hardware components to accomplish specific functions in accordance with embodiments of the invention. In this way, for instance, a processor (e.g., the illustrated processor 205, perhaps in conjunction with the illustrated processing acceleration unit 235), when executing such instructions, can serve as a means to perform many of the functions described elsewhere herein. These instructions can include operating systems and application programs, as described in detail above and/or as known in the art. Such instructions are illustrated in FIG. 2 as located within a working memory 240, including an operating system 245 and other code 250 (e.g., an application program), which are described above and/or designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

Other embodiments of the invention provide methods, which may be (but need not be) implemented using systems similar to those described above. FIG. 3 displays a process flow diagram illustrating a method 300 for consolidating/merging communications in accordance with one set of such embodiments. The method 300 can allow for automated and/or interactive creation of a message from a sender to a recipient using a communication medium. For ease of description, certain aspects of the method 300 will be described by reference to a communication processing system, examples of which are described elsewhere herein, but it should be appreciated that the scope of the invention is not limited to any particular architectural implementation; hence, methods of the invention may be performed in any suitable environment. Likewise, although the procedures illustrated on FIG. 3 are shown in a particular order for ease of illustration, it should be recognized that various embodiments may perform these procedures in a different order than illustrated, and various procedures may be repeated and/or omitted as appropriate without straying from the scope of the invention.

In accordance with the exemplary method 300, a trigger can be received (block 305). A trigger can be anything that indicates to the system that a communication may be ready for transmission to a recipient. Merely by way of example, a trigger can comprise an process running on the system that continually and/or periodically checks a communication source for communications to be sent to recipients. The communication source can be a hold file and/or a communication store (both described in detail below), which can be located on the communication processing system. Alternatively, the communication source can reside on and/or be incorporated by a separate system, which may be in communication with the communication processing system. In other embodiments, the trigger may be a user-initiated command to the system to check for communications waiting to be sent. In yet other embodiments, the mere presence of a communication to be transmitted may serve as the trigger. Triggers may also comprise account activity, particularly in embodiments relating to financial services: For instance, if an account reaches a certain status (such as delinquency), that status may serve as a trigger. Likewise, suspicious account activity may trigger a communication to the account holder (and/or another), and/or reaching certain usage criteria (which may trigger loyalty awards, for instance) may trigger a communication notifying the account holder (and/or another) of such awards, etc. Alternatively, the trigger can simply be the passage of a specified amount of time, such that the method is executed periodically.

In a particular set of embodiments, the process of consolidating and/or merging communications can include the generation of one or more communications, perhaps in response to some activity associated with an account, a marketing initiative, information disclosure regulations, the passage of time, etc. As used herein, the term “generate” should be understood to encompass any method by which a communication is created or composed. Merely by way of example, if an account becomes delinquent, the system can generate a communication to the account holder, notifying the account holder that the account is in a delinquent status, along with any other desired information (account balance, etc.). The generation of such a message may be automated (e.g., performed by the system), or it may be manually-triggered and/or composed. For instance, an administrator may generate a communication (e.g., by creating a file using a word processor, composing an email message, etc.) and/or instruct the system to generate communications to one or more recipients (e.g., for marketing purposes, etc.). In any case, the generation of the message may itself act as a trigger.

In certain embodiments, the communication processing system can check for available communications (block 310). This procedure can be (but need not be) performed in response to a trigger, such as one of those described above. Checking for available communications may comprise searching a hold file, computer file system, and/or a database for available communications. Available communications can comprise communications waiting to be transmitted and/or communications intended for a particular recipient and/or group of recipients. In some cases, a trigger may generate a communication, which then can become available for transmission. Merely by way of example, if an account becomes delinquent, the system may generate an automated communication comprising the necessary information (e.g., the account number, the delinquency status, etc.), which then could be processed and/or transmitted by the method 300.

Because the method 300 may be iterative, a communication medium may have been composed in a previous iteration (e.g., another communication may have triggered the process, and a communication medium may have been composed to incorporate a communication component for that communication), and checking for an available communication therefore can comprise searching for an available communication to be transmitted to the intended recipient of the composed communication medium.

If there are no communications available for transmission, the process can simply end. Alternatively, as shown by the broken lines, if a communication medium previously had been composed for another communication (as described in detail below), the process can proceed with respect to that communication medium (e.g., as described with respect to blocks 360-375, described below). If there is at least one communication available for transmission, however, the method 300 can comprise determining whether that communication qualifies for transmission (block 315). In some embodiments, all available communications may qualify for transmission by default, and block 315 therefore could be omitted. In other embodiments, however, some available communications may not qualify for transmission, for a variety of reasons.

Merely by way of example, in some implementations, the method 300 sometimes may be configured to transmit communications only by certain media, such as electronic mail. In this way, for example, embodiments of the invention may be configured to transmit using certain media at different times, so that for example, batches of printed mailings may be produced at certain times, while the system can by used to send electronic messages or make outgoing telephone communications at other times. Alternatively, embodiments of the invention can be used to support multiple modes of communication simultaneously, such that business rules may specify that a certain available communication (perhaps a legal notice) may be transmitted only by a different medium, such as by postal mailing. Thus, such a communication would not qualify for transmission during performance of the method 300 at that time, although it might qualify for transmission at a later time. In other embodiments, certain communications may not be important enough to qualify for transmission by themselves—such communications may be delayed (e.g., placed in a hold file, as described below, etc.) until another transmission is scheduled for communication—or may not qualify for transmission at any time, in which case they may be discarded, saved in a hold file, etc. At that point, the method 300 may stop processing that communication and/or may seek additional communications available for processing, for instance by consulting a hold file (block 320), which is described elsewhere herein.

In accordance with certain embodiments, if a communication qualifies for transmission, the urgency of the transmission may be determined (block 325). Merely by way of example, a communication may include a transmission deadline, such that the communication is considered urgent if the current date/time is within a certain period of the transmission deadline and/or if the transmission deadline has passed. (In some instances, therefore, the transmission deadline can represent merely a date/time after which the communication is considered urgent, while in other cases the transmission deadline can represent a date/time after which the communication is considered untimely.) Hence, evaluating the urgency of the communication may comprise comparing the communication's transmission deadline with the current date and/or time. In other cases, a communication may be considered urgent or non-urgent by its nature, irrespective of any deadlines. Thus, some communications (perhaps a delinquency notice, legal notification, etc.) may always be considered urgent, while other communications (perhaps a marketing message, etc.) may always be considered non-urgent.

If a given communication is considered urgent during the processing of method 300, it may trigger the composition and/or transmission of a message, as described in detail below. If the communication is not considered urgent, however, it may be more efficient to wait until a later time to send the communication. For instance, the method 300 may be configured to combine non-urgent communications with later, urgent communications for a consolidated transmission, thereby saving on transmission costs, etc. Thus, if a communication is considered non-urgent, it may be placed (and/or allowed to remain) in a hold file (block 330). The communication may then age in the hold file (block 335) until such time that the communication should be sent; for instance, if a communication includes a transmission deadline, as described above, the communication may remain in the hold file until the communication becomes urgent, based on the transmission deadline and/or other considerations. Alternatively, in a subsequent iteration of the method 300, one or more other communication(s) may be scheduled for transmission to the recipient of the communication in the hold file, and the communication in the hold file may then be selected for consolidation with the communication(s) scheduled for transmission.

If it is determined that the communication should be transmitted at the present time (for instance, as described above, in some embodiments, if the communication is considered urgent), the method 300 can include determining whether any other communication(s) are scheduled to be transmitted to the same recipient (in which case, a communication medium may have been composed to incorporated the scheduled (“pending”) communication components) (block 340). It should be noted that this step can, in some embodiments, take place before (and/or in lieu of) determining the urgency of the communication, such that even if the communication is not considered urgent, if another communication is scheduled to be transmitted, the non-urgent communication can be consolidated with the communication(s) pending for transmission. If one or more communication components are scheduled for transmission to the recipient (i.e., pending), the method 300 can include evaluating whether the current communication is compatible for consolidation with the pending communication components (block 345).

In some cases, business rules (which might be included in a rules store, as described below) can guide the evaluation. Merely by way of example, a business rule may dictate that a marketing message should never be consolidated with a delinquency message. Alternatively, although the pending message and the current message may be intended for transmission to the same recipient, business rules may specify that the communications should not be consolidated for some reason. Merely by way of example, the current communication and the pending communication(s) may relate to separate accounts, and the account holder may have instructed the sender that it wishes to receive separate communications for each account. In other cases, the pending communication(s) may require transmission by a certain medium (e.g., a paper mailing), while the current communication is more appropriate for a different medium (e.g., a telephone call, an electronic message and/or the like). In still other cases, business rules may dictate that the current communication and/or a pending communication should never be consolidated with any other communication (e.g., if one of the communications is a legal notice, which may be required by law to be transmitted separately from any other content).

If no communication components are pending for the recipient of the current communication and/or if the current communication is not compatible for consolidation with the pending communication components, the method 300 can comprise composing a communication medium for the transmission of the current communication (block 350). A communication medium can take one or more of several forms, some of which are described above, in accordance with various embodiments of the invention. In some cases, the communication may specify what type of medium should be used to transmit the communication. Merely by way of example, the communication (which might comprise and/or be associated with a “communication record”) may comprise a data file (such as, for instance, an XML file known to those skilled in the art), and the content of the communication may comprise one or more fields in that file. Other fields in the file may include additional information about the communication, such as the communication type (e.g., marketing message, legal notification, etc.), any transmission deadlines and/or urgency information (as described above), as well as transmission instructions, which can specify a required and/or preferred communication medium. In other embodiments, business rules may dictate the form of the communication medium: For instance, if the communication is a legal notification, business rules may dictate that a particular medium be used, while other rules may dictate that a different medium be used for other types of messages.

The process of composing a communication medium, therefore, can depend on the form of the medium, but it generally involves creating the medium and/or inserting the contents of the communication into the medium as a communication component. In some cases, including for instance where the communication medium is a paper mailing and/or a telephone call, composing the communication medium can comprise creating a virtual representation of the medium, which may be output subsequently, using an appropriate output device, to create a literal communication medium comprising the communication. Merely by way of example, if the communication is to be transmitted using the postal service, composing the communication medium may comprise creating a data file that may be interpreted by a printer to create a printed page. Such data files can be formatted according to the printer used to create the printed page and can include, inter alia, Postscript™ files, Portable Document Format™ files (PDF™ files), HTML files, XML files, ASCII files, PCL™ files and/or the like. Likewise, if the communication is to be transmitted via telephone call, composition of the communication medium can comprise creating a script file that can be used by a human and/or an IVR unit to transmit the communication via a telephone call.

In other cases, composing a communication medium may comprise creating the communication medium itself; for instance, if the communication is to be transmitted via email, composition of the communication medium can comprise creating a file and/or an electronic message to be transmitted. For electronic messages, depending on recipient preferences and/or other business rules (which may be stored in a rule store, if desired), the file and/or message may comprise plain text, rich text formatting (“RTF”), XML, HTML, MIME-encoded information, and/or any other known electronic message formatting conventions.

In accordance with some embodiments, composing the communication medium can comprise adding general information to the communication medium. Such information can include information about the recipient (address, general account information, electronic routing information, etc.), introductory language, opening and/or closing information (subject line, signature block, etc.) sender information (logos, contact information, etc.), and the like. Some of this general information (e.g., information about the sender) may not be specific to the recipient, while other of the general information may be recipient-specific. The communication processing system may reference other data sources in order to obtain the general information. Merely by way of example, if a particular communication is keyed to a given account number, an account database may be consulted to obtain data about the proper recipient, recipient address, etc. (It should be noted that outside data sources may be accessed as necessary at other points in method 300, including for example when receiving a trigger (block 305), etc., so that all necessary information about the recipient, account(s), etc. need not be included with the communication itself.) Alternatively, the communication may include all necessary information (recipient address, etc.) may be included in a stored record of the communication (for instance, an entry in a communication store), rendering consultation of additional data sources unnecessary.

As noted above, composing the communication medium can also comprise inserting the communication (and/or the substance of the communication) into the communication medium, perhaps as a communication component (and/or as part of an existing communication component). For instance, once the communication medium has been created, the text of the communication may be inserted into the communication medium. In some embodiments, the text of the communication may not comprise the entirety of the message to be sent to the recipient, and/or composing the communication medium can comprise the insertion of additional text, images, formatting, structure, etc. to the communication medium, thereby enhancing the readability, effectiveness, etc. of the communication. (Alternatively, the addition of such material may be thought of as one or more separate procedures, which are discussed in detail with respect to blocks 360-70, below.)

On the other hand, if additional communication(s) to the recipient are pending for transmission and/or the current communication is determined to be compatible with the pending communication components, the method 300 can comprise merging and/or consolidating the current communication for transmission with the pending communication components (block 355). Often, the pending communication component(s) already will have been inserted into one or more communication media, and consolidating the communications can comprise inserting the current communication into these same communication media. (Alternatively, consolidating the communications can comprise composing a new communication medium for transmission of both the pending communication(s) and the current communication.) It should be noted that the addition of a second communication component into the communication medium may be accomplished by adding the substance of the current communication to an existing communication component, such that the existing communication component incorporates both the pending communication and the current communication component.

At blocks 360-370, the message can be structured and/or formatted. Although shown as three separate blocks in FIG. 3 for ease of description, these procedures may be consolidated into a single procedure. Moreover, in various embodiments, these procedures may take place as part of the composition of a communication medium and/or the consolidation of communications. Hence, it should be appreciated that the organization of the described procedures is discretionary.

At block 360, structure optionally may be applied to the communication medium and/or any communication components contained therein. Applying structure can be thought of as any procedure in which one or more communication components are organized within a communication medium. For example, in some cases, business rules may specify how particular communications are to be consolidated. Merely by way of example, it may be desirable to present communications to the recipient arranged according to a particular order. Depending on the communications to be transmitted, a variety of ordering schemes may be employed. For example, a certain type of communication may be prioritized ahead of other types of communications, such that it should appear first on the communication medium, regardless of the order in which the communications are processed. In other cases, certain communications may be grouped for easy review by the recipient; for instance, a single message may include similar data (such as balance amounts, credit limits, etc.) for a plurality of accounts, and such information may be arranged in tabular fashion, etc. in order to present the necessary information in an efficient manner.

Optionally, the communication medium and/or certain communication components may be formatted for transmission to the recipient. Thus, at block 365, a determination may be made whether any formatting information is available for the communication component(s) incorporated in the communication medium. In some cases, a business rule may specify that certain types of communications should receive a particular type of formatting. In other cases, a communication may include a reference to formatting information. In still other cases, the system may be configured to check for formatting information in a particular location, which can depend on the communication to be formatted. If no formatting information is available and/or the communication/business rules specify that formatting should not be applied, the content of the communication (which may comprise text, graphics, etc.) may be inserted into the communication medium “as is,” that is without any additional formatting applied.

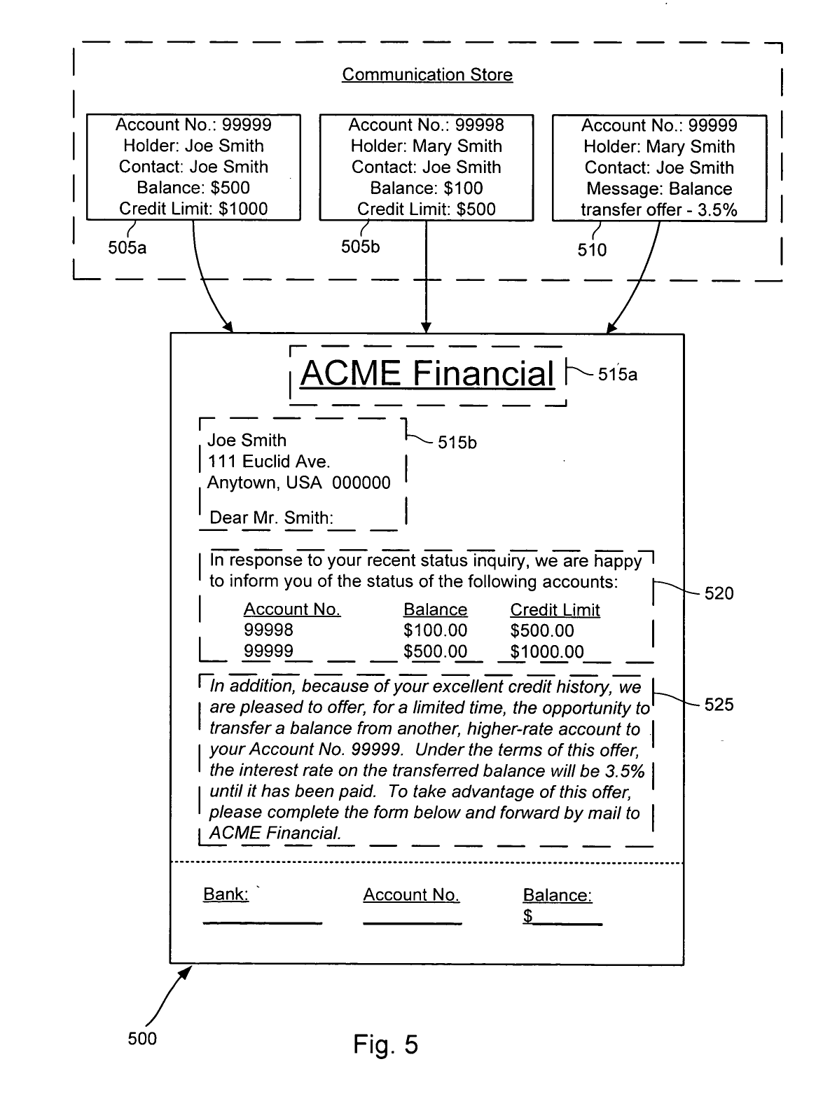

On the other hand, if formatting information is available and/or if the communication/business rules specify that formatting should be applied, one or more communication components may be formatted prior to transmission (block 370). (Depending on the embodiment, each communication component may be formatted before additional communication components are inserted into the message and/or all communication components may be formatted together, prior to transmission). Formatting information can be any information that may be used to modify and/or enhance the presentation of the information in a particular communication component. In some cases, for instance, considerations of efficient storage might dictate that a particular communication comprise only data specific to the communication, and formatting information may be used to present the data to the recipient in a usable manner. Hence, a communication might merely comprise information that a marketing message should be sent to the recipient offering a particular service and/or feature, and formatting information can be used to provide a context for that offer within the communication component. In other cases, formatting information can be used to provide an easy-to-read layout for the information presented in the communication; formatting information therefore can include font information, positioning information, graphical information (including, inter alia, text boxes, graphic advertisements, etc.). A few examples of formatting information are described in detail below with respect to FIG. 5. Based on the disclosure herein, one skilled in the art will recognize that the steps of applying structure and formatting to communications and/or communication components may be related in some instances, and in fact may comprise a single procedure.

At this point, the communication medium may be ready for output (block 375). Output may take one or more of several forms, which may depend on the type of communication medium used. For example, if the communication medium is paper, output may comprise printing the communication medium. Alternatively, the message may be queued for transmission electronically, placed in a calling queue and/or transmitted as a file or electronic message to a human operator/administrator (for telephone communication), and/or the like. In some cases, delayed and/or batch output may be desired, and the communication medium may be output to a file, database, etc. for transmission at a later time and/or as part of a batch.

As noted above, the described method 300 may be an iterative method, and once a given communication is processed, the method can reiterate for processing another communication. Iteration may take place at any particular point in the method, including without limitation (as illustrated), when a communication is determined to be inappropriate for transmission at the present time, after communication components have been inserted and/or consolidated into a communication medium (and/or after a communication medium has been composed), after structure has been applied to the communication component(s)/medium, after the communication component(s)/medium have been formatted, and/or after the communication medium has been output.

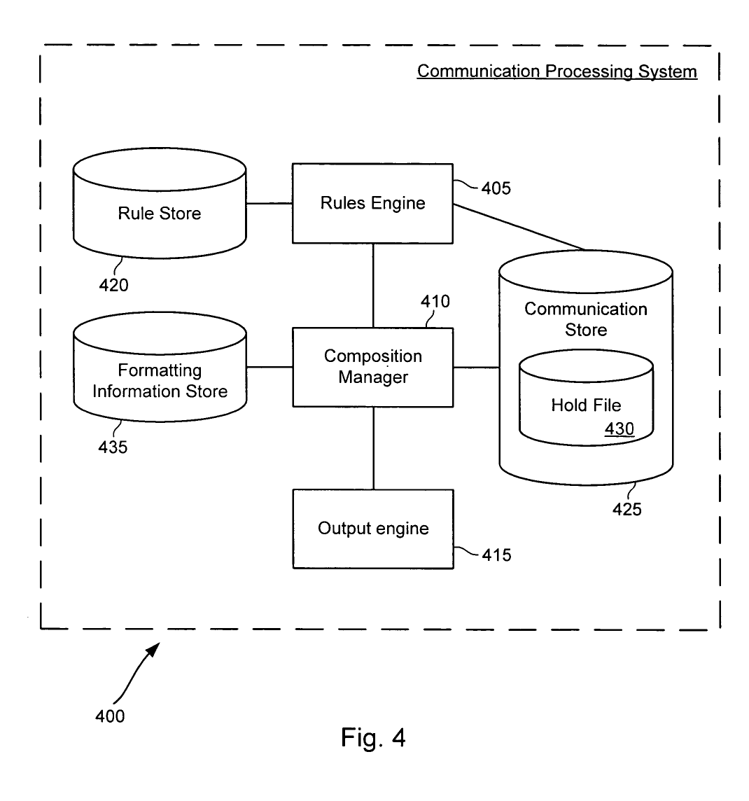

As noted above, the methods of the invention (including, for example, the exemplary methods 300 illustrated by FIG. 3) may be implemented in any suitable environment. Often, such methods may be implemented by a computer system, including without limitation a communication processing system, examples of which are described architecturally above. FIG. 4 provides a functional drawing of an exemplary communication processing system 400, which illustrates functionally the components that may be used to implement certain methods of the invention, including various of the methods described above.

The communication processing system 400 can comprise a plurality of functional components 405-415, some (or all) of which may be implemented by software running on a processor, perhaps as part of a system such as those described above with respect to FIGS. 1 and/or 2. In addition, the illustrated communication processing system 400 can include a rules store 420 and/or a communication store 425, each of which may be implemented by one or more directories, files, file structures, etc. and can reside on a hard drive, in system memory, etc. In particular implementations, the rules store 420 and/or the communication store 425 may comprise one or more databases, such as those described above, and/or the rules store and the communication store 425 may be incorporated within a single database. In some embodiments, the communication processing system 400 may also comprise a hold file 430, which can be incorporated within the communication store 425 (as illustrated in FIG. 4, for example) and/or which may be a stand-alone file, file system, directory, database, etc. A hold file can be any file that is used to hold communications (and/or records of communications) that, for whatever reason, should not be sent at a particular time. The hold file is sometimes referred to as a “pending file” by those skilled in the art but for purposes of clarity herein, the term “hold file” is used, to distinguish from communications which are “pending” (i.e., currently queued for transmission or other processing). While a pending (or hold) file is exemplary of this concept, those skilled in the art will appreciate that other methods of holding communication to be sent at a later time (and/or not to be sent at all) may be utilized by certain embodiments.

In operation, the rules engine may 405 may be used to configure the operation of the communication processing system 400, with respect to one or more business rules. Business rules may specify whether and/or when a communication should be processed/transmitted, how a communication should be presented (including whether/how communication components/media should be formatted and/or structured), a preferred/mandatory type of communication medium (either as a default or for a given communication), and the like. Additional examples of business rules are described above. The rules engine 405 may communicate with the rules store 420 to determine whether any rules apply to a given situation. The rules store 420 can provide an efficient, modifiable way for an administrator (or others) to configure the behavior of the communication processing system 400 under a variety of circumstances, allowing the system 400 to be responsive to changing business requirements, legal constraints, etc. Depending on the embodiment, rules stored in the rules store 420 may be accessed/configured using a specialized software application, a database client, a web client and/or the like. Alternatively, the rules may be text files (e.g., script files, etc.), which may be modifiable by a text editor, word processor, etc.

The rules engine may be in communication with a composition manager 410, which can be in further communication with the communication store 425 and/or the hold file 430, and the composition manager can be configured to access, modify, etc. records of communications, which can be located in the communication store 425 and/or the hold file 425. Merely by way of example, the composition manager 410 can query the communication store 425 and/or the hold file 430 to determine whether any communications are available for transmission. If a communication is available, the composition manager 410 may be configured to analyze the urgency of the communication and/or evaluate whether the communication should be processed/transmitted at the present time. The composition manager 410 may also be configured to access any additional information in an external data source (not shown on FIG. 4), as described above, in order to analyze the communication component and/or to obtain data necessary for transmission but not included in the communication, as described in detail above.

If the communication should be processed/transmitted, the composition manager 410 can perform these functions and, if desired, delete the communication from the communication store 425 and/or hold file 430. Alternatively, the composition manager 425 can update the record of the communication to indicate that it has been processed and/or transmitted, so that a record of the communication may remain in the communication store (e.g., for tracking purposes, etc.), but the communication record can indicate that further processing in future iterations is unnecessary. If, on the other hand, the communication should not be processed for some reason (e.g., business rules indicate that processing/transmission are not appropriate presently and/or the communication is considered non-urgent, as discussed above), the communication may be added to the hold file 430 for future processing. (Alternatively, a record may be made in the hold file 430, and the communication itself may remain in the communication store 425. For instance, in some embodiments, it may not be desirable to store “held” communications separately from other communications, in which case, the “held” communications may be stored in the communication store 425 generally, with a record made in the hold file indicating that such communications are to be held. In still other embodiments, the hold file 430 can be implemented by setting a flag in a communication and/or communication record stored generally in the communications store 425, indicating the “held” status of that communication.)

Processing a communication may comprise composing a communication medium for transmission of the communication component(s), perhaps with input from the rules engine 405 regarding which communication medium is most appropriate. Alternatively and/or in addition, the composition manager 410 may insert a communication component for the communication, consolidate the communication components with other communication components in the communication medium, perhaps as described with respect to FIG. 3, above, and the like. Also as mentioned above, the rules engine 405 may govern whether two or more given communications should be consolidated, and/or the communications records may indicate that consolidation is inappropriate in certain circumstances. The composition manager 410 may also apply structure to the communication component(s) and/or medium, as well as format the communication component(s)/medium.

If necessary, the composition manager 410 may obtain additional formatting information from a formatting information store 435, which can comprise one or more databases, files, etc. An administrator and/or user may add formatting information (which, as described above, can include additional text, positioning information, font information, graphics, etc.) to the formatting information store for use with certain communications and/or types of communications. Alternatively, a communication and/or communication record may include formatting information, which can be accessed by the composition manager 410 during the formatting process, and/or the communication may be inserted into the communication medium with formatting. Merely by way of example, if a communication is stored as part of an XML record in the communication store 425, the XML tags may include formatting information for the communication, and the composition manager may format the communication component according to those XML tags. Other known methods of formatting may be incorporated by other embodiments of the invention.

The composition manager 410 may also be in communication with an output engine 415, and after the composition manager has composed, structured, consolidated and/or formatted a communication medium, that communication medium (message) may be sent to the output engine 415 for output. The output engine 415, therefore, may be configured to produce an output message for transmission. The functioning of the output engine 415 (which may be controlled through the rules engine 405) can depend on the type of communication medium to be output, as well as on business rules and/or other constraints. For instance, the output engine 415 may comprise an electronic-mail server and may therefore be configured to transmit electronic-mail messages when appropriate. Alternatively and/or in addition, the output engine 415 may comprise a printer interface (including, for example, a print driver), and may be configured to transmit files to a printer for printing. In accordance with other embodiments, the output engine may comprise an IVR interface and/or may be configured to use an IVR interface to transmit communications by telephone, facsimile, etc. In further embodiments, the output engine may be configured to produce formatted output files, which may be saved to a file, hard drive, database, etc. for later transmission (using the output engine 415 and/or other means).

Based on the disclosure herein, those skilled in the art should appreciate that this functional description of the communication processing system 400 and it various components describes merely one way of implementing the methods and systems described herein; this exemplary description of one set of embodiments, therefore, should not be considered limiting: the functions described herein may be implemented under a variety of other architectures. Other embodiments, therefore, may feature various different configurations of the components described herein and/or may incorporate additional components, integrate various functions within consolidated components, and the like.

Turning now to FIG. 5, an exemplary communication medium 500 is illustrated. The exemplary communication medium 500 may be used to transmit a message comprising one or more communications intended for a single recipient. The exemplary communication medium 500 is illustrated as a paper and/or formatted electronic communication, although other forms, including those described above, as possible as well. As illustrated, the communication medium 500 incorporates and consolidates a plurality of communications 505, 510, which may be retrieved from a communication store.

Two of the communications 505 comprise status messages about a plurality of accounts, each of which has the same contact, “Joe Smith,” such that consolidation may be appropriate even though one of the communication 505a relates to a first account and the other communication 505b relates to a second, different account. Thus, the respective communications 505a, 505b may be (but need not be) independent of each other. These communications 505 may have been triggered by a status request from the contact and/or another authorized entity associated with the account(s). An additional communication 510 comprises a marketing message, offering a low-interest-rate balance transfer service, and is related to the same account as the communication 505a. In this example, the same entity maintains financial responsibility for both the first and second accounts, and no existing business rule prevents the consolidation of the first and additional communications (i.e., the communications are compatible).

As illustrated, all of the communications 505, 510, have been consolidated within a single communication medium. The communication medium 500 comprises some general information (e.g., 515), which may be included within one or more of the communications 505, 510 and/or obtained from an external data source, as described above. In addition, the communication medium 500 includes communication components 520, 525 relating to the incorporated communications 505, 510, respectively. The components 520, 525 have been structured (perhaps according to business rules), so that the communications relating to the recipient's status inquires have been grouped together in one component 520 (note that a communication component may include one or more communications), while the communication relating to the marketing message has been inserted in a component 525 underneath the other communications.

In addition, in the exemplary communication medium 500, the communication components 520, 520 have been formatted for efficient communication and/or enhanced presentation of the conveyed information. For example, the communications 505 incorporated within component 520 have been arranged in tabular form, perhaps in response to a business rule that controls the presentation of account status information. Additional text and subject headings have also been added to this component 520, in order to provide context for the recipient. Similarly, the other component 525 includes additional text designed to provide context to the communication, and to include standard terms of the marketing offer. The component 525 also has been formatted with an italicized font, to provide emphasis for the marketing message.

The exemplary communication medium 500 illustrated in FIG. 5 illustrates some of the features attendant to certain embodiments of the present invention. Additional features are described in detail above, and the exemplary medium 500 therefore should not be considered an exhaustive illustration of the variety of consolidation, structuring and/or formatting options available under various embodiments of the invention.

Likewise, as described herein, various embodiments of the invention provide inventive methods and systems for consolidating and/or merging a plurality of communications. The description above identifies certain exemplary embodiments for implementing the invention, but those skilled in the art will recognize that many modifications and variations are possible within the scope of the invention. The invention, therefore, is defined only by the claims set forth below.

1. In a relationship between an account holder and an account issuer, a computer system for consolidating a plurality of communications to the account holder, the computer system comprising:
a processor; and
a computer readable storage medium in communication with the processor, the computer readable storage medium comprising instructions executable by the processor to:
provide a communication medium;
receive a first trigger configured to instruct the computer system that a first communication is available for transmission to the account holder;
in response to the first trigger, access a first communication component for transmission to the account holder, the first communication component comprising the first communication;
insert the first communication component into the communication medium;
receive a second trigger configured to instruct the computer system that an additional communication may be available for transmission to the account holder, the second trigger being independent of the first trigger; and
determine the suitability of the additional communication for inclusion in the communication medium.

2. In a relationship between a sender and a recipient, a computer system for consolidating a plurality of communications to the recipient using a computer system, the computer system comprising:
a processor; and
a computer readable storage medium in communication with the processor, the computer readable storage medium comprising instructions executable by the processor to:
provide a first communication that is available for transmission to the recipient;
determine whether the first communication should be transmitted to the recipient;
if the first communication should be transmitted to the recipient:
insert a first communication component into a communication medium, the first communication component comprising the first communication;
determine whether an additional communication is pending to be sent to the recipient, the additional communication being independent of the first communication;
if there is an additional communication pending, insert a second communication component into the communication medium, the second communication component comprising the additional communication; and
transmit the communication medium; and
if the first communication should not be transmitted to the recipient, add the first communication to a hold file for inclusion in a subsequent communication medium.

3. In a relationship between a sender and a recipient, a computer system for consolidating a plurality of communications to the recipient, the system comprising:
a communication store configured to store a plurality of communications for the recipient;
a rules engine in communication with the communication store, the rules engine being configured to determine whether any of the plurality of communications should be transmitted to the recipient at a particular time, and if any of the plurality of communications should be transmitted to the recipient, to select that communication for transmission;
a composition manager in communication with the rules engine and the communication store, the composition manager being configured to access the selected communication and insert a first communication component into a communication medium, the first communication component comprising the selected communication.

4. A system as recited in claim 3, wherein at least one of the rules engine and the composition manager is embodied by instructions executed by a computer processor.

5. A system as recited in claim 3, wherein the communications store comprises a hold file.

6. A system as recited in claim 3, wherein the communications store comprises a database.

7. A system as recited in claim 3, further comprising a rule store in communication with the rules engine, the rule store comprising a set of business rules specifying criteria for determining when a communication should be transmitted to a recipient.

8. A system as recited in claim 7, wherein the criteria for determining when a communication should be transmitted to a recipient specifies that a communication should be transmitted according to a certain schedule.

9. A system as recited in claim 8, wherein specifying that a communication should be transmitted according to a certain schedule comprises specifying that a communication should be transmitted before a certain date.

10. A system as recited in claim 7, wherein the criteria for determining when a communication should be transmitted to a recipient specifies that a communication should be transmitted if the communication is considered urgent.

11. A system as recited in claim 10, wherein a communication is considered urgent if the communication has remained pending for a certain number of days.

12. A system as recited in claim 3, wherein, if the rules engine determines that a plurality of communications should be transmitted to the recipient at the particular time, each of the plurality of communications being independent of the others, the rules engine is further configured to determine whether each of the plurality of communications is suitable for inclusion with the others of the plurality of communications.

13. A system as recited in claim 12, wherein, if the rules engine determines that a plurality of communications should be transmitted to the recipient at the particular time and that at least two of the plurality of communications are suitable for inclusion with each other, the rules engine is further configured to select all of the at least two communications for transmission.

14. A system as recited in claim 13, wherein the composition manager is configured to access each of the at least two communications selected for transmission; insert a plurality of communication components into a communication medium, wherein each of the communication components comprises one of the at least two selected communications; and arrange each of the plurality of communication components within the communication medium.

15. A system as recited in claim 14, wherein the rules engine is further configured to provide instructions to the composition manager specifying how to arrange each of the plurality of communication components within the communication medium.

16. In a relationship between a sender and a recipient, a method of using a computer system to consolidate a plurality of communications to the recipient, the method comprising:
providing a communication medium;
receiving a first trigger configured to instruct the computer system that a first communication is available for transmission to the recipient;
in response to the first trigger, accessing a first communication for transmission to the recipient;
inserting a first communication component into the communication medium, the first communication component comprising the first communication;
receiving a second trigger independent of the first trigger and configured to instruct the computer system that an additional communication may be available for transmission to the recipient, the additional communication being independent of the first communication; and
determining the suitability of the additional communication for inclusion in the communication medium.

17. A method as recited in claim 16, further comprising generating the first communication for transmission to the recipient.

18. A method as recited in claim 17, wherein the first trigger comprises the generation of the first communication for transmission to the recipient.

19. A method as recited in claim 16, further comprising:
inserting a second communication component into the communication medium, the second communication component comprising the additional communication.

20. A method as recited in claim 19, wherein the second communication component is incorporated within the first communication component.

21. A method as recited in claim 16, further comprising determining whether the additional communication should be transmitted with the first communication.

22. A method as recited in claim 21, wherein determining whether the additional communication should be transmitted with the first communication comprises specifying that the additional communication should be transmitted according to a certain schedule.

23. A method as recited in claim 22, wherein specifying that the additional communication should be transmitted according to a certain schedule comprises specifying that a communication should be transmitted before a certain date.

24. A method as recited in claim 21, wherein determining whether the additional communication should be transmitted with the first communication comprises specifying that a communication should be transmitted if the additional communication is considered urgent.

25. A method as recited in claim 24 wherein a communication is considered urgent if the communication has remained pending for a certain number of days.

26. A method as recited in claim 21, further comprising, if the additional communication should not be transmitted with the first communication, holding the additional communication in a hold file for possible inclusion in a future communication medium.

27. A method as recited in claim 26, further comprising reviewing the additional communication at a subsequent time to determine whether the additional communication should be transmitted at that subsequent time.

28. A method as recited in claim 16, further comprising:
holding the additional communication in a hold file for transmission to the recipient at a later time.

29. A method as recited in claim 16, wherein the first communication is a scheduled communication, and wherein the first trigger is a schedule that specifies when the first communication should be transmitted.

30. A method as recited in claim 16, wherein the first communication is associated with a first account.

31. A method as recited in claim 30, wherein the first trigger is related to an activity associated with the first account.

32. A method as recited in claim 30, wherein the first account is associated with the recipient.

33. A method as recited in claim 30, wherein the additional communication is associated with a second account.

34. A method as recited in claim 33, wherein the first account is related to the second account.

35. A method as recited in claim 33, wherein the first account and the second account are associated with a single entity.

36. A method as recited in claim 35, wherein the single entity is a business.

37. A method as recited in claim 35, wherein the single entity is an individual.

38. A method as recited in claim 33, wherein the first account is associated with a first entity and wherein the second account is associated with a second entity.

39. A method as recited in claim 38, wherein the first entity is a business.

40. A method as recited in claim 39, wherein the second entity is an employee of the business.

41. A method as recited in claim 38, wherein the first entity is an individual.

42. A method as recited in claim 41, wherein the second entity is a dependent of the individual.

43. A method as recited in claim 38, wherein financial responsibility for the first and second accounts is vested with a single entity.

44. A method as recited in claim 43, wherein the single entity is selected from a group consisting of the first entity and the second entity.

45. A method as recited in claim 30, wherein the additional communication is associated with the first account.

46. A method as recited in claim 16, wherein at least one of the communication and the additional communication comprises a legal notification about an account.

47. A method as recited in claim 16, wherein at least one of the communication and the additional communication comprises a welcome notification for an account.

48. A method as recited in claim 16, wherein at least one of the communication and the additional communication comprises a marketing message.

49. A method as recited in claim 16, further comprising, based on business rules, arranging at least one of the communication components within the communication medium.

50. A method as recited in claim 16, further comprising formatting at least one of the communication components.

51. A method as recited in claim 16, wherein the communication medium is selected from the group consisting of an account statement and an insert to an account statement.

52. A method as recited in claim 16, wherein the communication medium comprises an electronic mail message.

53. A method as recited in claim 16, wherein the communication medium comprises a postal mailing.

54. A method as recited in claim 53, wherein the communication medium comprises a letter.

55. A method as recited in claim 16, wherein the communication medium comprises a short messaging service message.

56. A method as recited in claim 16, wherein the communication medium comprises a pager message.

57. A method as recited in claim 16, wherein the communication medium comprises a telephone call to the recipient.

58. A method as recited in claim 16, wherein the communication medium comprises a response to a telephone call from the recipient.

59. In a relationship between a sender and a recipient, a method of consolidating a plurality of communications to the recipient using a computer system, the method comprising:
providing a first communication that is available for transmission to the recipient;
determining whether the first communication should be transmitted to the recipient;
if the first communication should be transmitted to the recipient:
inserting a first communication component into a communication medium, the first communication component comprising the first communication;
determining whether an additional communication is pending to be sent to the recipient;
if there is an additional communication pending, inserting a second communication component into the communication medium, the second communication component comprising the additional communication; and
transmitting the communication medium; and
if the first communication should not be transmitted to the recipient, adding the first communication to a hold file for inclusion in a subsequent communication medium.

60. A method as recited in claim 59, wherein the additional communication is independent of the first communication.

61. A method as recited in claim 59, wherein determining whether the first communication should be transmitted to the recipient comprises determining whether the first communication meets urgency criteria.

62. A method as recited in claim 61, wherein determining whether the first communication meets urgency criteria comprises:
determining an interval during which the first communication should be transmitted to the recipient; and
determining whether a pending communication has been scheduled for transmission to the recipient during the interval.

63. A method as recited in claim 62, further comprising:
if a pending communication has been scheduled for transmission to the recipient during the interval, determining whether the first communication is suitable for inclusion with the pending communication.

64. A method as recited in claim 59, further comprising:
determining the suitability of the additional communication for inclusion in the communication medium.

65. A method as recited in claim 64, wherein determining the suitability of the additional communication for inclusion in the communication medium comprises analyzing whether a content of the additional communication is compatible with a content of the first communication.

66. A method as recited in claim 59, further comprising:
determining, based on a business rule, that the first communication should be transmitted using a particular type of communication medium.

67. A method as recited in claim 66, further comprising:
determining the suitability of the additional communication for inclusion in the particular type of communication medium, wherein inserting a first communication component into a communication medium comprises inserting the first communication into a communication medium of the particular type.

68. In a relationship between a sender and a recipient, a computer system for consolidating a plurality of communications to the recipient, the system comprising a processor and a computer readable storage medium in communication with the processor, the computer readable storage medium comprising instructions executable by the processor to perform the method of claim 16.

69. In a relationship between a sender and a recipient, a computer system for consolidating a plurality of communications to the recipient, the system comprising a processor and a computer readable storage medium in communication with the processor, the computer readable storage medium comprising instructions executable by the processor to perform the method of claim 59.
